(19) United States
(12) Patent Application Publication
(10) Pub. No.: US 2025/0079489 A1
(43) Pub. Date: Mar. 6, 2025

(54) FUEL CELL SYSTEM AND CONTROL METHOD FOR FUEL CELL SYSTEM

(71) Applicant: HONDA MOTOR CO., LTD., TOKYO (JP)

(72) Inventor: Shuto MANIWA, WAKO-SHI (JP)

(21) Appl. No.: 18/804,336

(22) Filed: Aug. 14, 2024

(30) Foreign Application Priority Data
Aug. 28, 2023 (JP) 2023-137999

(51) Int. Cl. H01M 8/04858; H01M 8/0258; H01M 8/0273; H01M 8/04119; H01M 8/0432; H01M 8/04955

(52) U.S. Cl. CPC H01M 8/0494; H01M 8/0258; H01M 8/0273; H01M 8/04164; H01M 8/04358; H01M 8/0491; H01M 8/04955

(57) ABSTRACT

A control unit performs water discharge in the first water discharge mode during electrical power generation at the time of stoppage in the case that a determination unit determines that the fuel cell stack is in moist condition, and the control unit performs water discharge in the second water discharge mode during the electrical power generation at the time of stoppage in the case that the determination unit determines that the fuel cell stack is not in moist condition.

### CROSS-REFERENCE TO RELATED APPLICATIONS

This application is based upon and claims the benefit of priority from Japanese Patent Application No. 2023-137999 filed on Aug. 28, 2023, the contents of which are incorporated herein by reference.

### BACKGROUND OF THE INVENTION

### Field of the Invention

The present invention relates to a fuel cell system and a method for controlling the fuel cell system.

### Description of the Related Art

In recent years, research and development have been conducted on fuel cells that contribute to energy efficiency in order to ensure that more people have access to affordable, reliable, sustainable and modern energy.

A power generation system including a fuel cell stack is referred to as a fuel cell system. The fuel cell stack includes a plurality of power generation cells. The power generation cell generates power by electrochemical reactions between a fuel gas (hydrogen-containing gas) and an oxygen-containing gas. Water is produced during power generation by the power generation cells. The water that is produced remains in the fuel cell stack or the like. Then, if the operation of the fuel cell system is stopped in a low temperature environment, the water remaining in the fuel cell stack or the like may freeze. If water freezes in a fuel cell system or the like, because flow of gas is restrained or blocked, the fuel cell stack cannot generate electrical power.

JP 2021-180076 A discloses that scavenging is performed at the end of operation of a fuel cell system. The scavenging is a process of blowing off impurities such as water and nitrogen from the fuel cell stack.

### SUMMARY OF THE INVENTION

It is desirable to properly discharge water from the fuel cell stack.

An object of the present invention is to solve the aforementioned problem.

According to a first aspect of the present invention, there is provided a fuel cell system including: a fuel cell stack having a plurality of power generation cells configured to generate electrical power using an oxygen-containing gas and a fuel gas; an oxygen-containing gas supplier configured to supply the oxygen-containing gas to the fuel cell stack; a supply path through which the oxygen-containing gas to be supplied to the fuel cell stack flows; a discharge path through which the oxygen-containing gas discharged from the fuel cell stack flows; a temperature sensor configured to detect a temperature of the fuel cell stack; and a control device configured to control the oxygen-containing gas supplier, wherein the control device includes: a control unit configured to execute a stoppage operation in which power generation is continued until a predetermined condition is met after receipt of a system shutdown command; an acquisition unit configured to acquire a temperature of the fuel cell stack before the stoppage operation; a determination unit configured to determine whether the fuel cell stack is in moist condition on a basis of at least the temperature of the fuel cell stack acquired by the acquisition unit, and the control unit is configured to enable execution of water discharge during execution of electrical power generation under the stoppage operation by selectively discharging water remaining in the fuel cell stack in either a first mode in which an amount of oxygen-containing gas supplied from the oxygen-containing gas supplier to the fuel cell stack is a first amount, or a second mode in which the amount is a second amount less than the first amount, the control unit is configured to execute the water discharge in the first mode during execution of electrical power generation under the stoppage operation, in a case that the determination unit determines that the fuel cell stack is in moist condition, and the control unit is configured to execute the water discharge in the second mode during execution of the electrical power generation under the stoppage operation, in a case that the determination unit determines that the fuel cell stack is not in moist condition.

According to a second aspect of the present invention, there is provided a method of controlling a fuel cell system including: a fuel cell stack having a plurality of power generation cells configured to generate electrical power using an oxygen-containing gas and a fuel gas; an oxygen-containing gas supplier configured to supply the oxygen-containing gas to the fuel cell stack; a supply path through which the oxygen-containing gas to be supplied to the fuel cell stack flows; a discharge path through which the oxygen-containing gas discharged from the fuel cell stack flows; a temperature sensor configured to detect a temperature of the fuel cell stack; and a control device configured to control the oxygen-containing gas supplier, wherein the control device executes a stoppage operation in which power generation is continued until a predetermined condition is met after receipt of a system shutdown command; acquires the temperature of the fuel cell stack before the stoppage operation; determines whether the fuel cell stack is in moist condition on a basis of at least the temperature of the fuel cell stack acquired; enables execution of water discharge during execution of electrical power generation under the stoppage operation by selectively discharging water remaining in the fuel cell stack in either a first mode in which an amount of oxygen-containing gas supplied from the oxygen-containing gas supplier to the fuel cell stack is a first amount, or a second mode in which the amount is a second amount less than the first amount; executes the water discharge in the first mode during execution of electrical power generation under the stoppage operation, in a case that the fuel cell stack is determined to be in moist condition; and executes the water discharge in the second mode during execution of the electrical power generation under the stoppage operation, in a case that the fuel cell stack is determined not to be in moist condition.

According to the present invention, water can be appropriately discharged from the fuel cell stack.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram of a fuel cell system;

FIG. 2 is an exploded perspective view of a power generation cell of the fuel cell stack;

FIG. 3 is a schematic view of a first separator;

FIG. 4 is a schematic view of a second separator;

FIG. 5 is a flowchart of a process for determining whether the fuel cell stack is in moist condition;

FIG. 6 is a diagram showing a map for determining the moist condition;

FIG. 7A is a diagram showing a change in instructed current values over time;

FIG. 7B is a diagram showing a change in temperature of the coolant over time;

FIG. 7C is a diagram showing time measured by a timer;

FIG. 7D is a diagram showing a change in a moist condition flag over time; and

FIG. 8 is a flowchart of a water discharge process executed during electrical power generation at the time of stoppage.

### DETAILED DESCRIPTION OF THE INVENTION

### 1. Configuration of Fuel Cell System 10

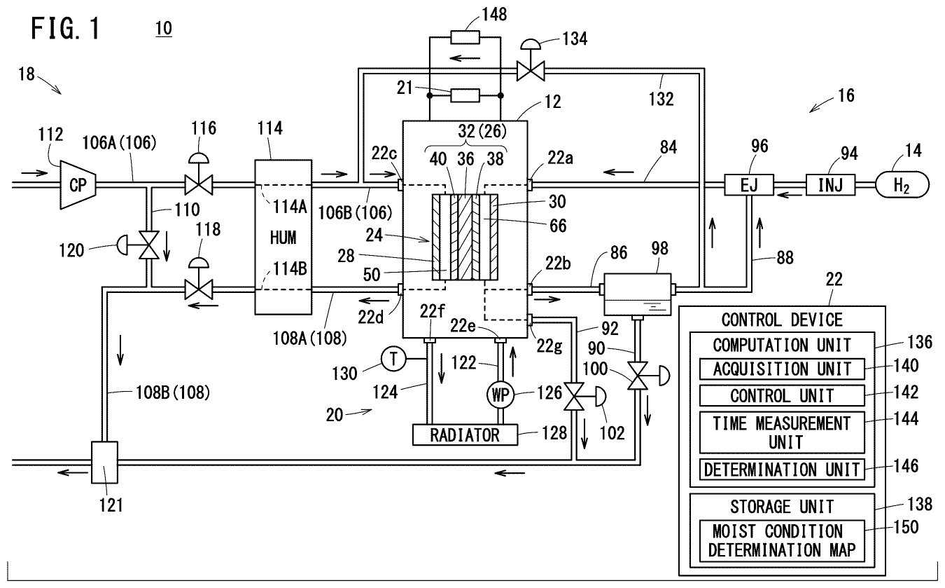

FIG. 1 is a schematic diagram of a fuel cell system 10. The fuel cell system 10 may be mounted on, for example, a vehicle (fuel cell vehicle). Apart from a vehicle, the fuel cell system 10 can be mounted on, a ship, an aircraft, a robot, or the like. The fuel cell system 10 can also be used as a power source in facilities, homes, and the like.

In the fuel cell system 10, a fuel gas and an oxygen-containing gas are used as reactant gases. The fuel gas is a hydrogen-containing gas. The oxygen-containing gas is a gas containing oxygen. The fuel gas and the oxygen-containing gas are individually supplied to a fuel cell stack 12 and subjected to electrochemical reactions. In the present specification, the fuel gas discharged from the fuel cell stack 12 without being consumed in the electrochemical reactions is also referred to as a fuel off-gas. Further, in the present specification, the oxygen-containing gas discharged from the fuel cell stack 12 without being consumed in the electrochemical reactions is also referred to as an oxygen-containing off-gas.

The fuel cell system 10 includes the fuel cell stack 12, a tank 14, an anode system 16, a cathode system 18, and a cooling system 20. The fuel cell system 10 includes a control device 22. The electrical power generated by the fuel cell stack 12 is supplied to a load 21. The tank 14 is filled with a high-pressure fuel gas.

The fuel cell stack 12 includes a fuel gas inlet 22a through which the fuel gas is supplied into the fuel cell stack 12, and a fuel gas outlet 22b through which the fuel off-gas is discharged from the fuel cell stack 12. The fuel cell stack 12 includes an oxygen-containing gas inlet 22c through which the oxygen-containing gas is supplied into the fuel cell stack 12, and an oxygen-containing gas outlet 22d through which the oxygen-containing off-gas is discharged from the fuel cell stack 12. The fuel cell stack 12 includes a coolant inlet 22e through which a coolant is supplied into the fuel cell stack 12, and a coolant outlet 22f through which the coolant is discharged from the fuel cell stack 12. The fuel cell stack 12 includes a water outlet 22g through which residual water is discharged from the fuel cell stack 12. The water outlet 22g is arranged in a lower portion of the fuel cell stack 12.

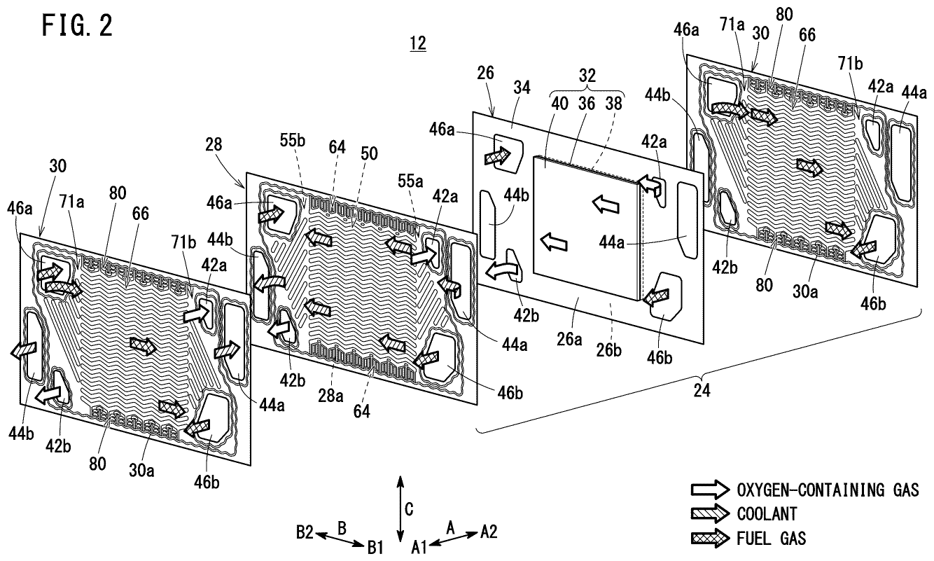

Here, the configuration of the fuel cell stack 12 will be described with reference to FIGS. 2 to 4. FIG. 2 is an exploded perspective view of a power generation cell 24 of the fuel cell stack 12. The fuel cell stack 12 is formed by stacking a plurality of power generation cells 24 in the arrow A direction. A compressive load is applied to the fuel cell stack 12 in the stacking direction of the plurality of power generation cells 24.

The power generation cell 24 has a horizontally long rectangular shape. The power generation cell 24 includes a membrane electrode assembly 26, and a pair of separators (first separator 28 and a second separator 30). The front surface 28a of the first separator 28 faces the first surface 26a of the membrane electrode assembly 26. The front surface 30a of the second separator 30 faces the second surface 26b of the membrane electrode assembly 26. The membrane electrode assembly 26 is sandwiched between the first separator 28 and the second separator 30.

The first separator 28 and the second separator 30 are formed of metal thin plates each having a corrugated cross section. In two adjacent power generation cells 24, the first separator 28 of one power generation cell 24 and the second separator 30 of the other power generation cell 24 are joined to each other. A coolant flow field (not shown) through which the coolant flows is formed between the first separator 28 and the second separator 30.

The membrane electrode assembly 26 includes a membrane electrode assembly (MEA) 32 and a resin frame 34. The MEA 32 has an electrolyte membrane 36, a cathode 40, and an anode 38. The electrolyte membrane 36 is interposed between the cathode 40 and the anode 38. The resin frame 34 protrudes outward from the outer periphery of the MEA 32.

One end of the longer side (one end on the arrow B1 side) of the power generation cell 24 is provided with an oxygen-containing gas supply passage 42a, a coolant supply passage 44a and a fuel gas discharge passage 46b. The oxygen-containing gas supply passage 42a is connected to the oxygen-containing gas inlet 22c. The oxygen-containing gas flows through the oxygen-containing gas supply passage 42a in the direction indicated by the arrow A2. The coolant supply passage 44a is connected to the coolant inlet 22e. The coolant flows through the coolant supply passage 44a in the direction indicated by the arrow A2. The fuel gas discharge passage 46b is connected to the fuel gas outlet 22b. The fuel gas flows through the fuel gas discharge passage 46b in the direction indicated by the arrow A1.

The other end of the longer side (the other end on the arrow B2 side) of the power generation cell 24 is provided with a fuel gas supply passage 46a, a coolant discharge passage 44b, and an oxygen-containing gas discharge passage 42b. The fuel gas supply passage 46a is connected to the fuel gas inlet 22a. The fuel gas flows through the fuel gas supply passage 46a in the direction indicated by the arrow A2. The coolant discharge passage 44b is connected to the coolant outlet 22f. The coolant flows through the coolant discharge passage 44b in the direction indicated by the arrow A1. The oxygen-containing gas discharge passage 42b is connected to the oxygen-containing gas outlet 22d. The oxygen-containing gas flows through the oxygen-containing gas discharge passage 42b in the direction indicated by the arrow A1.

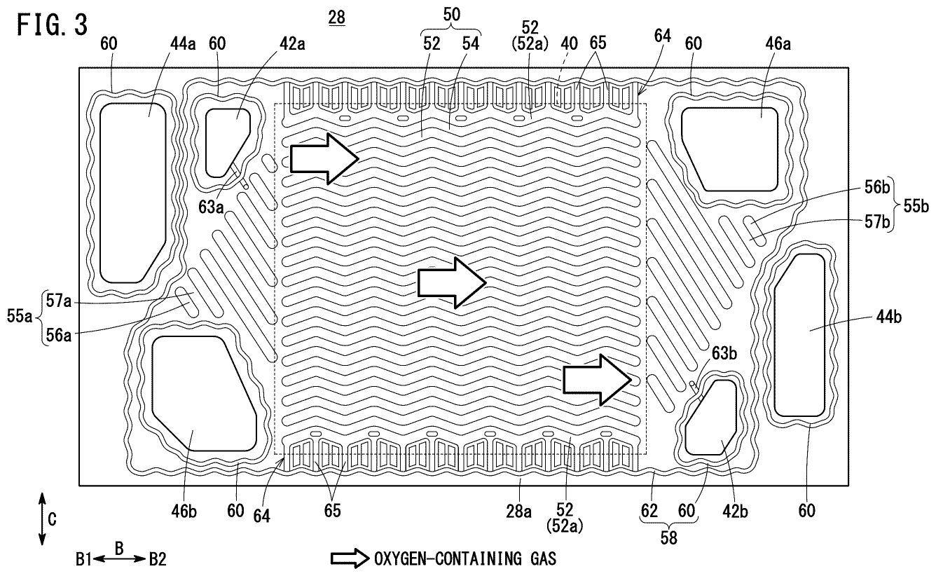

FIG. 3 is a schematic view of the first separator 28. FIG. 3 shows the front surface 28a of the first separator 28. The first separator 28 is formed in a rectangular shape. An oxygen-containing gas flow field 50 is formed on the front surface 28a of the first separator 28. When viewed in the arrow A1 direction or the arrow A2 direction shown in FIG. 2, the oxygen-containing gas flow field 50 overlaps the cathode 40 of the membrane electrode assembly 26. The oxygen-containing gas flow field 50 extends in the longitudinal direction of the power generation cell 24 (arrow B direction).

The oxygen-containing gas flow field 50 includes a plurality of first flow field ridges 52 and a plurality of first flow field grooves 54. The first flow field ridges 52 protrude in the arrow A2 direction. The first flow field grooves 54 are recessed in the arrow A1 direction. Each of the first flow field ridges 52 and the first flow field grooves 54 extends in a wave form in the arrow B direction. In the oxygen-containing gas flow field 50, the first flow field ridges 52 and the first flow field grooves 54 are alternately arranged in the flow field width direction (the arrow C direction).

Two first guides 55a, 55b are formed on the front surface 28a of the first separator 28. The first guide 55a includes a plurality of first guide ridges 56a and a plurality of first guide grooves 57a extending from the oxygen-containing gas supply passage 42a toward the oxygen-containing gas flow field 50. The first guide 55b includes a plurality of first guide ridges 56b and a plurality of first guide grooves 57b extending from the oxygen-containing gas flow field 50 toward the oxygen-containing gas discharge passage 42b.

A first seal set 58 for preventing leakage of any of the reaction gases (the oxygen-containing gas and the fuel gas) and the coolant is provided on the front surface 28a of the first separator 28. The first seal set 58 includes a plurality of first passage seals 60 and a first flow field seal 62. The first passage seals 60 and the first flow field seal 62 protrude in the arrow A2 direction. One first passage seal 60 is provided for one passage (e.g., the oxygen-containing gas supply passage 42a, and the like). The first passage seals 60 individually surround the passages. The first flow field seal 62 surrounds a region where the oxygen-containing gas flow field 50, the first guides 55a, 55b, and the passages (the oxygen-containing gas supply passage 42a, the oxygen-containing gas discharge passage 42b, the fuel gas supply passage 46a, and the fuel gas discharge passage 46b) through which the reactant gases flow are disposed. Each of the plurality of first passage seals 60 and the first flow field seal 62 is pressed against the resin frame 34 of the membrane electrode assembly 26.

The first passage seal 60 surrounding the oxygen-containing gas supply passage 42a includes a tunnel 63a. The tunnel 63a connects the oxygen-containing gas supply passage 42a to the first guide 55a adjacent to the oxygen-containing gas supply passage 42a. Although one tunnel 63a is shown in FIG. 3, a plurality of tunnels 63a are actually provided. Similarly, the first passage seal 60 surrounding the oxygen-containing gas discharge passage 42b includes a tunnel 63b. The tunnel 63b connects the oxygen-containing gas discharge passage 42b to the first guide 55b adjacent to the oxygen-containing gas discharge passage 42b. Although one tunnel 63b is shown in FIG. 3, a plurality of tunnels 63b are actually provided.

The oxygen-containing gas flows from the oxygen-containing gas supply passage 42a into the oxygen-containing gas flow field 50 through the tunnels 63a and the first guide 55a. The oxygen-containing gas is supplied to the cathode 40 while flowing through the oxygen-containing gas flow field 50. The oxygen-containing gas not consumed in the electrochemical reactions is discharged as the oxygen-containing off-gas from the oxygen-containing gas flow field 50 to the oxygen-containing gas discharge passage 42b through the first guide 55b and the tunnels 63b.

First bypass stopping protrusions 64 are formed on the front surface 28a of the first separator 28. The first bypass stopping protrusions 64 are disposed between the edges of the oxygen-containing gas flow field 50 in the flow field width direction (first outermost flow field ridges 52a) and the first flow field seal 62. The first bypass stopping protrusions 64 prevent the oxygen-containing gas supplied from the oxygen-containing gas supply passage 42a from flowing between the first outermost flow field ridges 52a and the first flow field seal 62 toward the oxygen-containing gas discharge passage 42b. That is, the first bypass stopping protrusions 64 prevent the oxygen-containing gas from bypassing the oxygen-containing gas flow field.

The first bypass stopping protrusions 64 include a plurality of first bypass blockers 65 extending in the arrow C direction. The plurality of first bypass blockers 65 are arranged along the arrow B direction. The first bypass blockers 65 protrude in the arrow A2 direction. The height of the first bypass blockers 65 is slightly lower than the height of the first flow field seal 62. The first bypass blockers 65 do not receive the compressive load applied in the arrow A direction. Thus, a minute gap is formed between the first bypass blockers 65 and the resin frame 34 of the membrane electrode assembly 26.

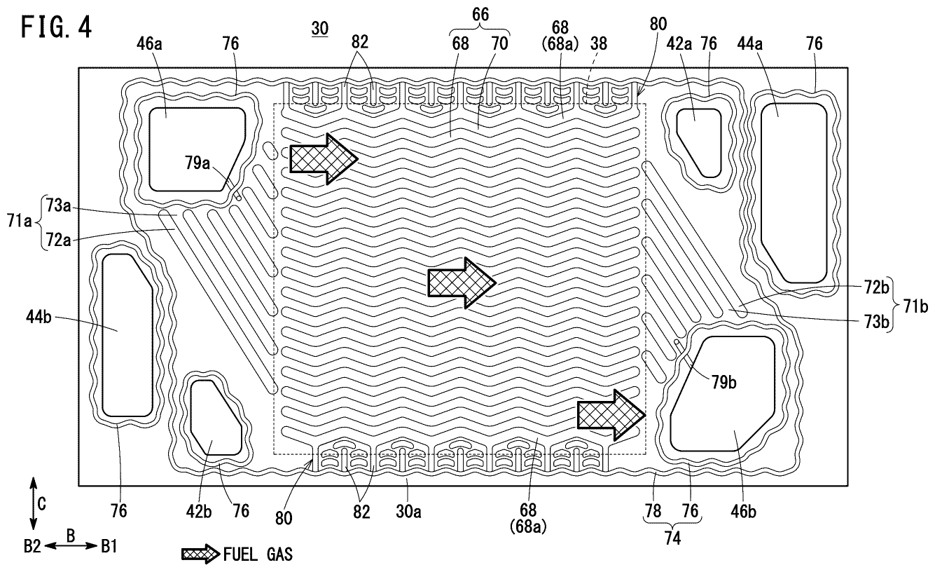

FIG. 4 is a schematic view of the second separator 30. FIG. 4 shows the front surface 30a of the second separator 30. The second separator 30 is formed in a rectangular shape. A fuel gas flow field 66 is formed on the front surface 30a of the second separator 30. When viewed in the arrow A1 direction or the arrow A2 direction shown in FIG. 2, the fuel gas flow field 66 overlaps the anode 38 of the membrane electrode assembly 26. The fuel gas flow field 66 extends in the longitudinal direction of the power generation cell 24 (arrow B direction).

The fuel gas flow field 66 includes a plurality of second flow field ridges 68 and a plurality of second flow field grooves 70. The second flow field ridges 68 protrude in the arrow A1 direction. The second flow field grooves 70 are recessed in the arrow A2 direction. Each of the second flow field ridges 68 and the second flow field grooves 70 extends in a wave form in the arrow B direction. In the fuel gas flow field 66, the second flow field ridges 68 and the second flow field grooves 70 are alternately arranged in the flow field width direction (the arrow C direction).

Two second guides 71a, 71b are formed on the front surface 30a of the second separator 30. The second guide 71a includes a plurality of second guide ridges 72a and a plurality of second guide grooves 73a extending from the fuel gas supply passage 46a toward the fuel gas flow field 66. The second guide 71b includes a plurality of second guide ridges 72b and a plurality of second guide grooves 73b extending from the fuel gas flow field 66 toward the fuel gas discharge passage 46b.

A second seal set 74 for preventing leakage of any of the reaction gases (the oxygen-containing gas and the fuel gas) and the coolant is provided on the front surface 30a of the second separator 30. The second seal set 74 includes a plurality of second passage seals 76 and a second flow field seal 78. The second passage seals 76 and the second flow field seal 78 protrude in the arrow A1 direction. One second passage seal 76 is provided for one passage (e.g., the fuel gas supply passage 46a, and the like). The second passage seals 76 individually surround the passages. The second flow field seal 78 surrounds a region where the fuel gas flow field 66, the second guides 71a, 71b, and the passages (the oxygen-containing gas supply passage 42a, the oxygen-containing gas discharge passage 42b, the fuel gas supply passage 46a, and the fuel gas discharge passage 46b) through which the reactant gases flow are disposed. Each of the plurality of second passage seals 76 and the second flow field seal 78 is pressed against the resin frame 34 of the membrane electrode assembly 26.

The second passage seal 76 surrounding the fuel gas supply passage 46a includes a tunnel 79a. The tunnel 79a connects the fuel gas supply passage 46a to the second guide 71a adjacent to the fuel gas supply passage 46a. Although one tunnel 79a is shown in FIG. 4, a plurality of tunnels 79a are actually provided. Similarly, the second passage seal 76 surrounding the fuel gas discharge passage 46b includes a tunnel 79b. The tunnel 79b connects the fuel gas discharge passage 46b to the second guide 71b adjacent to the fuel gas discharge passage 46b. Although one tunnel 79b is shown in FIG. 4, a plurality of tunnels 79b are actually provided.

The fuel gas flows from the fuel gas supply passage 46a into the fuel gas flow field 66 through the tunnels 79a and the second guide 71a. The fuel gas is supplied to the anode 38 while flowing through the fuel gas flow field 66. The fuel gas not consumed in the electrochemical reactions is discharged as the fuel off-gas from the fuel gas flow field 66 to the fuel gas discharge passage 46b through the second guide 71b and the tunnels 79b.

Second bypass stopping protrusions 80 are formed on the front surface 30a of the second separator 30. The second bypass stopping protrusions 80 are disposed between the edges of the fuel gas flow field 66 in the flow field width direction (second outermost flow field ridges 68a) and the second flow field seal 78. The second bypass stopping protrusions 80 prevent the fuel gas supplied from the fuel gas supply passage 46a from flowing between the second outermost flow field ridges 68a and the second flow field seal 78 toward the fuel gas discharge passage 46b. That is, the second bypass stopping protrusions 80 prevent the fuel gas from bypassing the fuel gas flow field.

The second bypass stopping protrusions 80 include a plurality of second bypass blockers 82 extending in the arrow C direction. The plurality of second bypass blockers 82 are arranged along the arrow B direction. The second bypass blockers 82 protrude in the arrow A1 direction. The height of the second bypass blockers 82 is slightly lower than the height of the second flow field seal 78. The second bypass blockers 82 do not receive the compressive load applied in the arrow A direction. Thus, a minute gap is formed between the second bypass blockers 82 and the resin frame 34 of the membrane electrode assembly 26.

Returning to FIG. 1, the configuration of the fuel cell system 10 will be described. The anode system 16 includes a fuel gas supply path 84, a fuel gas discharge path 86, a circulation path 88, a first water discharge path 90, and a second discharge path 92. The anode system 16 also includes an injector 94, an ejector 96, a gas-liquid separator 98, a first water discharge valve 100, and a second water discharge valve 102.

The fuel gas supply path 84 is connected to the outlet of the tank 14 and the fuel gas inlet 22a of the fuel cell stack 12. The fuel gas supply path 84 is equipped with the injector 94 and the ejector 96. The ejector 96 is disposed closer to the fuel cell stack 12 than the injector 94.

The fuel gas discharge path 86 is connected to the fuel gas outlet 22b of the fuel cell stack 12 and a supply port of the gas-liquid separator 98. The circulation path 88 is connected to a discharge port of the gas-liquid separator 98 and the ejector 96.

The first water discharge path 90 is connected to a drainage outlet of the gas-liquid separator 98 and to an inlet of a diluter 121. An outlet of the diluter 121 is connected to an exhaust orifice of the vehicle. The first water discharge path 90 is provided with the first water discharge valve 100. The second water discharge path 92 is connected to the water outlet 22g of the fuel cell stack 12 and to the first water discharge path 90. The second water discharge path 92 is provided with the second water discharge valve 102.

The cathode system 18 includes an oxygen-containing gas supply path 106, an oxygen-containing gas discharge path 108 (discharge path), and a bypass path 110. The cathode system 18 includes a compressor 112 (oxygen-containing gas supplier), a humidifier (HUM) 114, a first stop valve 116, a second stop valve 118, and a bypass valve 120.

The oxygen-containing gas supply path 106 is connected to an air intake of the vehicle and the oxygen-containing gas inlet 22c of the fuel cell stack 12. The oxygen-containing gas supply path 106 is provided with the compressor 112, the first stop valve 116, and a humidifier supply path 114A of the humidifier 114. A portion of the oxygen-containing gas supply path 106 on the upstream side of the humidifier 114 is referred to as an oxygen-containing gas supply path 106A. A portion of the oxygen-containing gas supply path 106 on the downstream side of the humidifier 114 is referred to as an oxygen-containing gas supply path 106B. The oxygen-containing gas supply path 106A is provided with the compressor 112 and the first stop valve 116. The first stop valve 116 is disposed closer to the humidifier 114 than the compressor 112.

The oxygen-containing gas discharge path 108 is connected to the oxygen-containing gas outlet 22d of the fuel cell stack 12 and an inlet of the diluter 121. The oxygen-containing gas discharge path 108 is provided with a humidifier discharge path 114B of the humidifier 114 and the second stop valve 118. A portion of the oxygen-containing gas discharge path 108 on the upstream side of the humidifier 114 is referred to as an oxygen-containing gas discharge path 108A. A portion of the oxygen-containing gas discharge path 108 on the downstream side of the humidifier 114 is referred to as an oxygen-containing gas discharge path 108B. The oxygen-containing gas discharge path 108B is provided with the second stop valve 118.

The bypass path 110 is connected to the oxygen-containing gas supply path 106A between the compressor 112 and the first stop valve 116, and to the oxygen-containing gas discharge path 108B on the downstream side of the second stop valve 118. The bypass path 110 is provided with the bypass valve 120.

The anode system 16 and the cathode system 18 are connected to each other by a connection path 132. The connection path 132 is connected to the circulation path 88 of the anode system 16 and the oxygen-containing gas supply path 106B of the cathode system 18. The connection path 132 is provided with a bleed valve 134.

The cooling system 20 includes a coolant supply path 122 and a coolant discharge path 124. The cooling system 20 includes a pump 126, a radiator 128, and a temperature sensor 130.

The coolant supply path 122 is connected to a fluid outlet of the radiator 128 and the coolant inlet 22e of the fuel cell stack 12. The coolant supply path 122 is provided with the pump 126. The coolant discharge path 124 is connected to the coolant outlet 22f of the fuel cell stack 12 and a fluid inlet of the radiator 128. The temperature sensor 130 is attached to the coolant discharge path 124. The temperature sensor 130 detects the temperature of the coolant flowing through the coolant discharge path 124. The temperature of the coolant flowing through the coolant discharge path 124 corresponds to the temperature inside the fuel cell stack 12 (stack temperature).

An impedance measuring device 148 may be attached to the fuel cell stack 12. For example, the impedance measuring device 148 measures the impedance of the fuel cell stack 12 by superimposing alternating current on the output of the plurality of power generation cells 24.

The control device 22 is constituted by an ECU (Electronic Control Unit). The control device 22 includes a computation unit 136 and a storage unit 138. The computation unit 136 is, for example, a processor such as a central processing unit (CPU) or a graphics processing unit (GPU). More specifically, the computation unit 136 can be configured by a processing circuit (processing circuitry). The computation unit 136 controls each device by executing a program stored in the storage unit 138. At least a portion of the computation unit 136 may be realized by an integrated circuit such as an ASIC (Application Specific Integrated Circuit), an FPGA (Field-Programmable Gate Array), or the like. Further, at least a portion of the computation unit 136 may be constituted by an electronic circuit including a discrete device.

The computation unit 136 includes an acquisition unit 140, a control unit 142, a time measurement unit 144, and a determination unit 146. The acquisition unit 140 acquires information from electronic components (sensors, ECUs, and the like) other than the control device 22. The control unit 142 controls the operations of the injector 94, the compressor 112, the pump 126, the valves, and the like. The time measurement unit 144 measures by a timer the implementation time of the water discharge control to be described later. The determination unit 146 determines whether the fuel cell stack 12 is in a moist-condition-predicted state and whether the fuel cell stack 12 is in moist condition.

The storage unit 138 may be made up of a volatile memory (not shown), and a non-volatile memory (not shown), as a computer-readable storage medium. Examples of the volatile memory include, for example, a RAM (Random Access Memory) or the like. As the non-volatile memory, there may be cited, for example, a ROM (Read Only Memory), a flash memory, or the like. Data, etc. may be stored in the volatile memory, for example. Programs, tables, maps, and the like are stored, for example, in the nonvolatile memory. At least a portion of the storage unit 138 may be provided in the processor, the integrated circuit, or the like, which were described above.

### 2 Fluid Flow in Fuel Cell System 10

### 2-1 Fluid Flow in Anode System 16

The injector 94 injects the fuel gas supplied from the tank 14, toward the downstream side of the fuel gas supply path 84. The fuel gas injected by the injector 94 is supplied to the fuel gas inlet 22a of the fuel cell stack 12 through the fuel gas supply path 84. The unreacted fuel gas in the fuel cell stack 12 is discharged as a fuel off-gas from the fuel gas outlet 22b of the fuel cell stack 12. The fuel off-gas contains hydrogen that has not reacted with oxygen, nitrogen that had been contained in the oxygen-containing gas and has permeated the electrolyte membrane 36, and water produced by reactions between oxygen and hydrogen.

The fuel off-gas is supplied to the gas-liquid separator 98 via the fuel gas discharge path 86. The gas-liquid separator 98 separates the fuel off-gas into a gas component (fuel off-gas) and a liquid component (water). The fuel off-gas discharged from the gas-liquid separator 98 flows through the circulation path 88 and is supplied to the ejector 96. The fuel off-gas introduced into the ejector 96 from the gas-liquid separator 98 is mixed with the fuel gas that is injected by the injector 94.

### 2-2 Fluid Flow in Cathode System 18

The compressor 112 discharges the oxygen-containing gas (air) taken from the outside of the vehicle, toward the downstream side of the oxygen-containing gas supply path 106. The oxygen-containing gas discharged from the compressor 112 is supplied to the oxygen-containing gas inlet 22c of the fuel cell stack 12 through the oxygen-containing gas supply path 106. The unreacted oxygen-containing gas in the fuel cell stack 12 is discharged as an oxygen-containing off-gas from the oxygen-containing gas outlet 22d of the fuel cell stack 12. The oxygen-containing off-gas contains components that have been contained in the oxygen-containing gas and water generated by the reactions between oxygen and hydrogen.

The oxygen-containing off-gas is discharged to the diluter 121 through the oxygen-containing gas discharge path 108. The oxygen-containing off-gas contains water. In the humidifier 114, a part of the water contained in the oxygen-containing off-gas is used for humidifying the oxygen-containing gas flowing through the humidifier supply path 114A.

### 2-3 Fluid Flow in Cooling System 20

The pump 126 discharges the coolant toward the coolant inlet 22e of the fuel cell stack 12. The coolant discharged from the pump 126 is supplied to the coolant inlet 22e of the fuel cell stack 12 through the coolant supply path 122. The coolant that has flowed through the fuel cell stack 12 is discharged from the coolant outlet 22f of the fuel cell stack 12. The coolant discharged from the coolant outlet 22f is supplied to the radiator 128 via the coolant discharge path 124. The coolant that has dissipated heat in the radiator 128 is sucked into the pump 126.

### 3 Water Discharge during Electrical Power Generation at Stoppage

When the operation of the vehicle is stopped, the control device 22 stops the operation of the fuel cell system 10. The computation unit 136 (control unit 142) of the control device 22 performs power generation to make the electrolyte membrane 36 uniformly moistened in an appropriate moist condition before stopping power generation by the fuel cell system 10. This is called electrical power generation at the time of stoppage. During the electrical power generation at the time of stoppage, the control unit 142 performs power generation control so as to control output current of the fuel cell stack 12 at a predetermined value. During the electrical power generation at the time of stoppage, the fuel gas, the oxygen-containing gas and the coolant are supplied to the fuel cell stack 12, and electricity is supplied from the fuel cell stack 12 to the load 21 (for example, a battery).

The control unit 142 also causes water to be discharged from the fuel cell stack 12 during the electrical power generation at the time of stoppage. This is also referred to as scavenging. For example, the control unit 142 increases the flow rates of the reactant gases to be higher than those in normal power generation operation, thereby discharging water from the fuel cell stack 12 and the discharge paths. Specifically, the control unit 142 controls the flow rate of the oxygen-containing gas discharged from the compressor 112 (the flow rate of the oxygen-containing gas to be supplied to the fuel cell stack 12). Water can be discharged from the fuel cell stack 12 also by increasing the flow rate of the fuel gas. However, if the flow rate of the fuel gas is increased during the electrical power generation at the time of stoppage, the fuel gas is consumed wastefully. Therefore, it is preferable to discharge water from the fuel cell stack 12 by increasing the amount of the oxygen-containing gas supplied. In the present specification, control for discharging water from the fuel cell stack 12 (and the oxygen-containing gas discharge path 108) during the electrical power generation at time of stoppage is referred to as water discharge control or scavenging control. The water includes liquid water remaining in the fuel cell stack 12 and the oxygen-containing gas discharge path 108, and highly humidified air containing water vapor.

The control unit 142 can execute, during the electrical power generation at the time of stoppage, water discharge control in the cathode system 18 in either the first water discharge mode or the second water discharge mode. When the determination unit 146 determines that the fuel cell stack 12 is in moist condition, the control unit 142 performs water discharge in the first water discharge mode. When the determination unit 146 determines that the fuel cell stack 12 is not in the moist condition, the control unit 142 performs water discharge in the second water discharge mode. The moist condition refers to a state in which the fuel cell stack 12 contains water in an amount equal to or greater than a predetermined amount, and the humidity within the fuel cell stack 12 is equal to or greater than a predetermined humidity.

In the first water discharge mode, the oxygen-containing gas is discharged from the compressor 112 at a first flow rate. In the second water discharge mode, the oxygen-containing gas is discharged from the compressor 112 at a second flow rate. The first flow rate is greater than the second flow rate. Therefore, water discharge in the first water discharge mode can discharge a larger amount of water from the fuel cell stack 12 than that in the second water discharge mode.

For example, water tends to be accumulated in and around the first bypass stopping protrusions 64, the first guides 55a, 55b, and the like shown in FIG. 3. When the flow rate of the oxygen-containing gas supplied to the fuel cell stack 12 is increased, the water content of the electrolyte membrane 36 decreases. Then, the electrolyte membrane 36 absorbs water accumulated in the first bypass stopping protrusions 64, and next time discharged from the electrolyte membrane 36, the water is discharged to the oxygen-containing gas flow field 50. The water discharged to the oxygen-containing gas flow field 50 flows out of the fuel cell stack 12. That is, execution of water discharge in the first water discharge mode can facilitate removal of water accumulated in the first bypass stopping protrusions 64. Further, execution of water discharge in the first water discharge mode can facilitate removal of water accumulated in the first guides 55a, 55b.

Similarly, water tends to be accumulated in and around the second bypass stopping protrusions 80, the second guides 71a, 71b, and the like shown in FIG. 4. When the flow rate of the oxygen-containing gas supplied to the fuel cell stack 12 is increased, the electrolyte membrane 36 absorbs water accumulated in the second bypass stopping protrusions 80 and the like, and next time discharged from the electrolyte membrane 36, the water is discharged to the oxygen-containing gas flow field 50. The water discharged to the oxygen-containing gas flow field 50 flows out of the fuel cell stack 12. That is, the execution of water discharge in the first water discharge mode can also facilitate removal of water accumulated in the second bypass stopping protrusions 80. Further, execution of water discharge in the first water discharge mode can also facilitate removal of water accumulated in the second guides 71a, 71b.

### 3-1 Determination of Moist Condition of Fuel Cell Stack 12

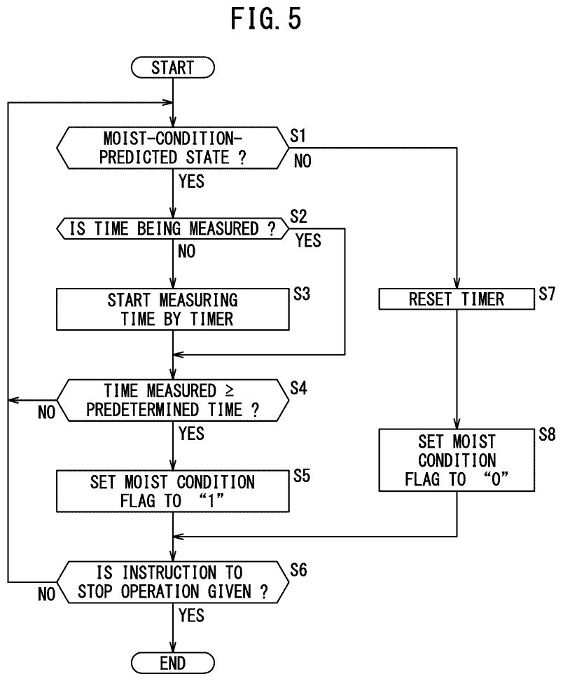

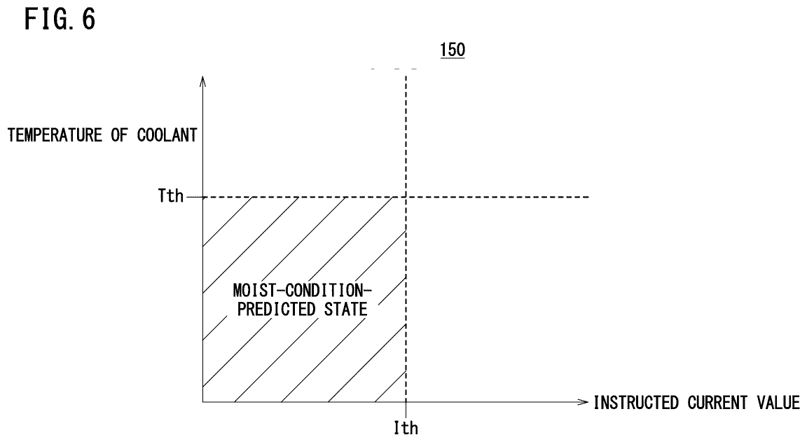

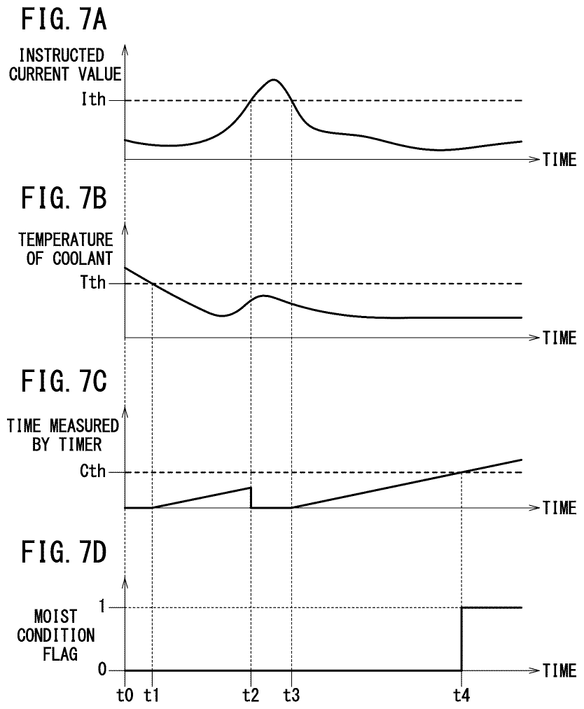

FIG. 5 is a flowchart of a process for determining a moist condition of the fuel cell stack 12. FIG. 6 is a diagram showing a map 150 for determining the moist condition. FIG. 7A is a diagram showing a change in instructed current values over time. FIG. 7B is a diagram showing a change in temperature values of the coolant over time. FIG. 7C is a diagram showing time measured by a timer. FIG. 7D is a diagram showing a change in the moist condition flag over time.

As described above, whether water is discharged in the first water discharge mode or the second water discharge mode is determined depending on whether the fuel cell stack 12 is in moist condition. Whether the fuel cell stack 12 is in moist condition is determined during operation of the fuel cell system 10 (during operation of the vehicle). An example of the determination of the moist condition of the fuel cell stack 12 will be described with reference to FIG. 5.

In the determination process to be described with reference to FIG. 5, the fuel cell stack 12 is determined to be in moist condition when the moist-condition-predicted state continues for a predetermined period of time. The moist-condition-predicted state is a state in which the fuel cell stack 12 is highly likely to be in moist condition. Here, the moist-condition-predicted state is determined on the basis of the output current of the fuel cell stack 12 and the temperature of the fuel cell stack 12. The output current of the fuel cell stack 12 is regarded as being substantially equal to the current value instructed from the ECU of the vehicle. The temperature of the fuel cell stack 12 is regarded as being substantially equal to the temperature of the fluid discharged from the fuel cell stack 12. Therefore, in the moist condition determination process to be described below, the instructed current value (output current value) from the ECU of the vehicle and a temperature value (stack temperature) detected by the temperature sensor 130 are used for judging the moist-condition-predicted state. The temperature of the oxygen-containing off-gas may be used instead of the temperature of the coolant.

In step S1, the determination unit 146 determines whether the fuel cell stack 12 is in the moist-condition-predicted state. The determination unit 146 uses, for example, a moist condition determination map 150 shown in FIG. 6. The moist condition determination map 150 associates a combination of the instructed current value and the temperature value of the coolant with the state of the fuel cell stack 12 (whether the fuel cell stack 12 is in the moist-condition-predicted state). As shown in FIG. 6, the moist condition determination map 150 associates a combination of an instructed current value lower than the current threshold Ith and a temperature value of the coolant lower than the temperature threshold Tth with the moist-condition-predicted state. The reason why the moist condition determination map 150 shows such association is that the fuel cell stack 12 is likely to be in moist condition when the output current value of the fuel cell stack 12 is relatively low and the temperature of the fuel cell stack 12 is relatively low.

The acquisition unit 140 acquires an instructed current value of the fuel cell stack 12 from the ECU of the vehicle. The acquisition unit 140 acquires the temperature value of the coolant from the temperature sensor 130. The determination unit 146 determines whether the fuel cell stack 12 is in the moist-condition-predicted state based on the instructed current value, the temperature value of the coolant, and the moist condition determination map 150.

If the fuel cell stack 12 is in the moist-condition-predicted state (step S1: YES), the process proceeds to step S2. For example, as shown in FIG. 7A, the instructed current values are lower than the current threshold Ith between the time point t1 and the time point t2. As shown in FIG. 7A, the instructed current values are lower than the current threshold Ith between the time point t3 and the time point t4. As shown in FIG. 7B, the temperature of the coolant becomes lower than the temperature threshold Tth after the time point t1. The determination unit 146 determines that the fuel cell stack 12 is in the moist-condition-predicted state between the time point t1 and the time point t2. The determination unit 146 determines that the fuel cell stack 12 is in the moist-condition-predicted state between the time point t3 and the time point t4.

On the other hand, when the fuel cell stack 12 is not in the moist-condition-predicted state (step S1: NO), the process proceeds to step S7. For example, as shown in FIG. 7B, the coolant temperature is higher than the temperature threshold Tth between the time point t0 and the time point t1. As shown in FIG. 7A, the instructed current values are higher than the current threshold Ith between the time point t2 and the time point t3. The determination unit 146 determines that the fuel cell stack 12 is not in the moist-condition-predicted state between the time point to and the time point t1. The determination unit 146 determines that the fuel cell stack 12 is not in the moist-condition-predicted state between the time point t2 and the time point t3.

In step S2, the time measurement unit 144 determines whether or not the time is being measured. In the case that the time is being measured (step S2: YES), the process proceeds to step S4. On the other hand, when the time is not being measured (step S2: NO), the process proceeds to step S3.

Upon transitioning from step S2 to step S3, the time measurement unit 144 starts measuring time by a timer. For example, as shown in FIG. 7C, the timer starts clocking at time point t1 and time point t3. The timer continues to count time between the time point t1 and the time point t2. The timer continues to count time between the time point t3 and the time point t4. Upon completion of step S3, the process transitions to step S4.

Upon transitioning from step S2 or step S3 to step S4, the determination unit 146 compares the time measured by the timer with the predetermined time Cth. The predetermined time Cth is a time threshold value for determining whether the fuel cell stack 12 is in moist condition. In the moist condition determination process, the fuel cell stack 12 is determined to be in moist condition when the moist-condition-predicted state continues for the predetermined time Cth. In the case that the time period measured by the timer is greater than or equal to the predetermined time Cth (step S4: YES), the process proceeds to step S5. For example, as shown in FIG. 7C, the time period measured by the timer becomes equal to the predetermined time Cth at the time point t4. On the other hand, in the case that the time period measured by the timer is less than the predetermined time Cth (step S4: NO), the process returns to step S1.

Upon transitioning from step S4 to step S5, the determination unit 146 sets the moist condition flag to “1”. For example, as shown in FIG. 7D, the moist condition flag is set to “1” at the time point t4. Upon completion of step S5, the process transitions to step S6.

Upon transitioning from step S5 or step S8 to be described below to step S6, the control unit 142 determines whether or not a command to stop the operation of the fuel cell system 10 has already been given. An operator of the vehicle performs an off operation on an unillustrated ignition switch (also referred to as a power switch) to stop the operation of the vehicle. When the acquisition unit 140 acquires an off signal associated with the off operation on the ignition switch, the control unit 142 determines that the command to stop the operation of the fuel cell system 10 is given. If the command to stop the operation of the fuel cell system 10 has already been given (step S6: YES), the series of process steps shown in FIG. 5 is brought to an end. On the other hand, if the command to stop the operation of the fuel cell system 10 has not been given yet (step S6: NO), the process returns to step S1.

Upon transitioning from step S1 to step S7, the time measurement unit 144 resets the timer. For example, as shown in FIG. 7C, the timer is reset during the time between the time point to and the time point t1 and the time between the time point t2 and the time point t3. Upon completion of step S7, the process transitions to step S8.

In step S8, the control unit 142 sets the moist condition flag to “0”. For example, as shown in FIG. 7D, the moist condition flag is set to “0” during the time between the time to and the time point t4. Upon completion of step S8, the process transitions to step S6.

### 3-2 Water Discharge Process Executed During Electrical Power Generation at Stoppage Operation

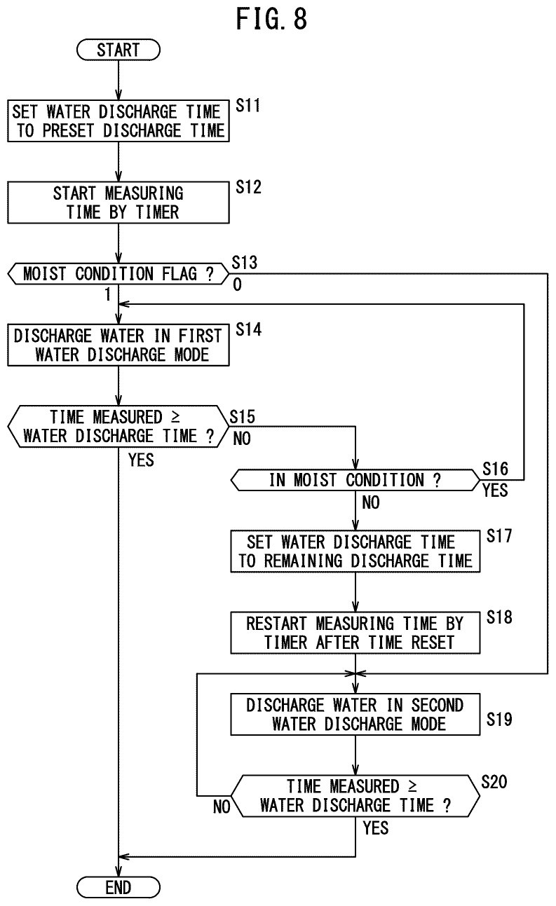

FIG. 8 is a flowchart of a water discharge process executed during electrical power generation at the time of stoppage. The series of process steps shown in FIG. 8 is executed after the series of process steps shown in FIG. 5 is brought to an end. In the water discharge process described below, the first water discharge mode can be switched to the second water discharge mode during the water discharge control.

In step S11, the time measurement unit 144 sets a water discharge time for which the water discharge control is being executed. Here, the time measurement unit 144 sets the water discharge time according to a preset discharge time stored in the storage unit 138. Upon completion of step S11, the process transitions to step S12.

In step S12, the time measurement unit 144 starts measuring time by the timer. That is, the time measurement unit 144 starts measuring the execution time of the water discharge control. Upon completion of step S12, the process transitions to step S13.

In step S13, the determination unit 146 determines whether the fuel cell stack 12 is in moist condition on the basis of the moist condition flag set in the process shown in FIG. 5. In the case that the moist condition flag is set to 1 (step 13: 1), the process proceeds to step S14. That is, when the fuel cell stack 12 is in moist condition, the process proceeds to step S14. On the other hand, in the case that the moist condition flag is set to 0 (step S13: 0), the process proceeds to step S19. That is, when the fuel cell stack 12 is not in moist condition, the process proceeds to step S19.

Upon transitioning from step S13 or step S16 to be described below to step S14, the control unit 142 executes water discharge in the first water discharge mode. In the first water discharge mode, the control unit 142 controls the operation of the compressor 112 such that the flow rate of the oxygen-containing gas discharged from the compressor 112 becomes the first flow rate. Thus, the oxygen-containing gas is supplied to the fuel cell stack 12 and the oxygen-containing gas discharge path 108 at the first flow rate. In this case, a relatively large amount of oxygen-containing gas is supplied to the fuel cell stack 12 and to the oxygen-containing gas discharge path 108. With a large amount of oxygen-containing gas supplied, water remaining in the fuel cell stack 12 and the oxygen-containing gas discharge path 108 is sufficiently discharged. In the first water discharge mode, the control unit 142 controls the rotation speed of the pump 126 to a first rotation speed. Upon completion of step S14, the process transitions to step S15.

In step S15, the control unit 142 compares the time period measured by the timer (first execution time) with the water discharge time. In the case that the time period is greater than or equal to the water discharge time (step S15: YES), the water discharge control is brought to an end. In this case, the control unit 142 stops the compressor 112 and the pump 126. Further, the control unit 142 sequentially closes each valve. On the other hand, in the case that the time period measured by the timer is less than the water discharge time (step S15: NO), the process proceeds to step S16.

Upon transitioning from step S15 to step S16, the determination unit 146 determines whether the fuel cell stack 12 is in moist condition. For example, the determination unit 146 may perform the moist condition determination based on the moist condition determination map 150. When the moist condition determination map 150 is used, the determination unit 146 determines that the fuel cell stack 12 is in moist condition when the combination of the instructed current value (predetermined value) and the temperature value of the coolant falls within the region of the moist-condition-predicted state. Alternatively, the determination unit 146 may perform the moist condition determination based on the impedance of the fuel cell stack 12. The impedance of the fuel cell stack 12 is measured by the impedance measuring device 148. In the case that the fuel cell stack 12 is in moist condition (step S16: YES), the process returns to step S14. On the other hand, in the case that the fuel cell stack 12 is not in moist condition (step S16: NO), the process proceeds to step S17.

Upon transitioning from step S16 to step S17, the time measurement unit 144 calculates the remaining water discharge time by subtracting the first execution time, which is the execution time of water discharge in the first water discharge mode, from the preset discharge time stored in the storage unit 138. Further, the time measurement unit 144 sets the remaining water discharge time as the water discharge time (second execution time). Upon completion of step S17, the process transitions to step S18.

In step S18, the time measurement unit 144 resets the timer and then starts measuring time by the timer. That is, the time measurement unit 144 starts measuring the execution time of the water discharge control in the second water discharge mode. Upon completion of step S18, the process transitions to step S19.

Upon transitioning from step S13, step S18 or step S20 to be described below to step S19, the control unit 142 executes water discharge in the second water discharge mode. In the case that the process transitions from step S18 to step S19, the control unit 142 switches the water discharge mode from the first water discharge mode to the second water discharge mode. In the second water discharge mode, the control unit 142 controls the operation of the compressor 112 such that the flow rate of the oxygen-containing gas discharged from the compressor 112 becomes the second flow rate. Thus, the oxygen-containing gas is supplied to the fuel cell stack 12 and to the oxygen-containing gas discharge path 108 at the second flow rate. In this case, the oxygen-containing gas is supplied to the fuel cell stack 12 and the oxygen-containing gas discharge path 108 at a flow rate lower than that in the first water discharge mode and higher than that in the normal power generation operation. Since the water discharge in the first water discharge mode is switched to the water discharge in the second water discharge mode, the water can be appropriately discharged from the fuel cell stack 12, but the fuel cell stack 12 is prevented from being excessively dried. In the second water discharge mode, the control unit 142 controls the rotation speed of the pump 126 to a second rotation speed. The second rotation speed is higher than the first rotation speed. Upon completion of step S19, the process transitions to step S20.

In step S20, the control unit 142 compares the time period measured by the timer with the water discharge time. In the case that the time period is greater than or equal to the water discharge time (step S20: YES), the water discharge control is brought to an end. In this case, the control unit 142 stops the compressor 112 and the pump 126. Further, the control unit 142 sequentially closes each valve. On the other hand, in the case that the time period measured by the timer is less than the water discharge time (step S20: NO), the process returns to step S19.

As described above, in the case that the fuel cell stack 12 is in moist condition, the control unit 142 performs water discharge in the first water discharge mode. In the case that the fuel cell stack 12 is no longer in moist condition before a predetermined water discharge time (preset discharge time) is reached, the control unit 142 performs water discharge in the second water discharge mode.

In the series of process steps shown in FIG. 8, the processes of step S17 and step S18 can be omitted. That is, the timer 144 may not necessarily calculate the second execution time for executing the water discharge in the second water discharge mode. In this case, the control unit 142 performs the water discharge in the second water discharge mode until the time measured by the timer reaches the water discharge time set in step S11.

### 4. Operations and Effects

If the water content of the fuel cell stack 12 is too high, the water may freeze. Further, if the water content of the fuel cell stack 12 is too high, iron is easily dissolved in water from metal components. The water containing iron deteriorates the electrolyte membrane 36. Therefore, it is preferable to appropriately discharge water from the fuel cell stack 12 so that the water content of the fuel cell stack 12 does not become too high.

When the amount of the oxygen-containing gas supplied to the fuel cell stack 12 is increased, the water discharge from the fuel cell stack 12 can be facilitated. On the other hand, if the fuel cell stack 12 is dried out more than necessary, the fuel cell stack 12 may deteriorate.

In the above embodiment, the control unit 142 performs water discharge in the first water discharge mode in the case that the fuel cell stack 12 is in moist condition. That is, during electrical power generation at the time of stoppage, the control unit 142 relatively increases the amount of the oxygen-containing gas supplied to the fuel cell stack 12. In this manner, it is possible to facilitate discharge of water from the fuel cell stack 12, and particularly facilitate removal of water accumulated in or around the first bypass stopping protrusions 64, the first guides 55a, 55b, the second bypass stopping protrusions 80, the second guides 71a, 71b, and the like. On the other hand, the control unit 142 performs the water discharge control in the second water discharge mode in the case that the fuel cell stack 12 is not in moist condition. That is, during the electrical power generation at the time of stoppage, the control unit 142 relatively reduces the amount of the oxygen-containing gas supplied to the fuel cell stack 12. According to the embodiment, it is possible to facilitate removal of water from portions of the fuel cell stack 12 through which water is difficult to flow. Further, according to the embodiment, it is possible to discharge water from the fuel cell stack 12 while suppressing excessive drying of the fuel cell stack 12. That is, according to the present invention, water can be appropriately discharged from the fuel cell stack 12.

In the above embodiment, the control unit 142 switches the water discharge control from the first water discharge mode to the second water discharge mode as the state of the fuel cell stack 12 changes from the moistened state to the predetermined dried state during the water discharge control. As described above, according to the embodiment, because the water discharge control is switched from the first water discharge mode to the second water discharge mode, the water is appropriately discharged from the fuel cell stack 12, while the fuel cell stack 12 is prevented from being excessively dried out.

In the above embodiment, the control unit 142 performs the water discharge control for a water discharge time set to a preset discharge time. According to the above embodiment, it is possible to prevent the water discharge control from being performed for a longer time than necessary.

In the water discharge control in the first water discharge mode, power consumption by the compressor 112 is increased. In the above embodiment, the control unit 142 makes the number of rotations of the pump 126 during water discharge in the first water discharge mode smaller than the number of rotations of the pump 126 during water discharge in the second water discharge mode. In this manner, according to the embodiment, it is possible to suppress an increase in power consumption by the entire fuel cell system 10.

### 5 Supplementary Note

With respect to the above disclosure, the following additional remarks are disclosed.

### Supplementary Note 1

The first disclosure is to provide the fuel cell system (10) including: the fuel cell stack (12) having the plurality of power generation cells (24) configured to generate electrical power using the oxygen-containing gas and the fuel gas; the oxygen-containing gas supplier (112) configured to supply the oxygen-containing gas to the fuel cell stack; the supply path (106) through which the oxygen-containing gas to be supplied to the fuel cell stack flows; the discharge path (108) through which the oxygen-containing gas discharged from the fuel cell stack flows; the temperature sensor (130) configured to detect a temperature of the fuel cell stack; and the control device (22) configured to control the oxygen-containing gas supplier, wherein the control device includes: the control unit (142) configured to execute a stoppage operation in which power generation is continued until a predetermined condition is met after receipt of a system shutdown command; the acquisition unit (140) configured to acquire a temperature of the fuel cell stack before the stoppage operation; a determination unit (146) configured to determine whether the fuel cell stack is in moist condition on the basis of at least the temperature of the fuel cell stack acquired by the acquisition unit, and the control unit is configured to enable execution of water discharge during execution of electrical power generation under the stoppage operation by selectively discharging water remaining in the fuel cell stack in either the first mode in which the amount of oxygen-containing gas supplied from the oxygen-containing gas supplier to the fuel cell stack is the first amount, or the second mode in which the amount is the second amount less than the first amount, the control unit is configured to execute the water discharge in the first mode during execution of electrical power generation under the stoppage operation, in the case that the determination unit determines that the fuel cell stack is in moist condition, and the control unit is configured to execute the water discharge in the second mode during execution of the electrical power generation under the stoppage operation, in the case that the determination unit determines that the fuel cell stack is not in moist condition.

According to the configuration described above, it is possible to facilitate removal of water from portions of the fuel cell stack through which water is difficult to flow. Further, according to the configuration described above, it is possible to discharge water from the fuel cell stack while suppressing excessive drying of the fuel cell stack. That is, according to the configuration described above, water can be appropriately discharged from the fuel cell stack.

### Supplementary Note 2

In the fuel cell system according to Supplementary Note 1, the determination unit may determine whether the fuel cell stack is in moist condition on the basis of the temperature of the fuel cell stack and the output current value of the fuel cell stack.

### Supplementary Note 3

In the fuel cell system according to Supplementary Note 2, the determination unit may acquire the temperature of the fuel cell stack and the output current value before starting the stoppage operation, and determine that the fuel cell stack is in the moist-condition-predicted state in a case that the temperature of the fuel cell stack is lower than a predetermined temperature threshold and the output current value is lower than a predetermined current threshold, and determine that the fuel cell stack is in moist condition in a case that the moist-condition-predicted state continues for a predetermined time (Cth) before starting the stoppage operation.

### Supplementary Note 4

In the fuel cell system according to Supplementary Note 1, each of the power generation cells may include the assembly (26) of the electrolyte membrane (36), the anode (38) and the cathode (40), and the pair of separators (28, 30) sandwiching the assembly, and each of the separators may include the reactant gas flow field (50, 66) through which the oxygen-containing gas or the fuel gas flows, the seal (62, 78) surrounding the reactant gas flow field, and the bypass stopping portion (64, 80) formed between the edge (52a, 68a) of the reactant gas flow field in a flow field width direction and the seal to prevent the oxygen-containing gas or the fuel gas from bypassing the reactant gas flow field.

The water accumulated in the bypass stopping portion is not easily discharged by the oxygen-containing gas flowing at the normal flow rate of the oxygen-containing gas during the stoppage operation (the second flow rate of the oxygen-containing gas in the second water discharge mode). On the other hand, the oxygen-containing gas flowing at the first flow rate of the oxygen-containing gas in the first water discharge mode can facilitate removal of water from the bypass stopping portion.

### Supplementary Note 5

In the fuel cell system according to Supplementary Note 1, the determination unit may further determine whether the fuel cell stack is in moist condition during the water discharge in the first water discharge mode, and the control unit may switch from the water discharge in the first water discharge mode to the water discharge in the second water discharge mode in the case that the determination unit determines that the fuel cell stack is no longer in moist condition during the water discharge in the first water discharge mode.

According to the above-described arrangement, because the water discharge control is switched from the first water discharge mode to the second water discharge mode, the water is appropriately discharged from the fuel cell stack, while the fuel cell stack is prevented from being excessively dried out. Further, even when the fuel cell stack is no longer in the moistened state (that is, in the predetermined dried state), the liquid water remaining in the exhaust device (for example, the second stop valve) provided in the discharge path can be discharged by performing the water discharge in the second water discharge mode. Consequently, it is possible to prevent the liquid water inside the exhaust device from freezing while the fuel cell system is stopped, thus preventing the fuel cell system from being unable to generate electrical power when started.

### Supplementary Note 6

In the fuel cell system according to Supplementary Note 5, the control unit may measure a first execution time which is an execution time of the water discharge in the first water discharge mode, determine the second execution time which is an execution time of the water discharge in the second water discharge mode based on the first execution time, and execute water discharge in the second water discharge mode during the second execution time.

### Supplementary Note 7

In the fuel cell system according to Supplementary Note 5, the control unit may measure the first execution time which is an execution time of the water discharge in the first water discharge mode, determine the second execution time which is an execution time of the water discharge in the second water discharge mode by subtracting the first execution time from the preset water discharge time, and execute water discharge in the second water discharge mode for the second execution time.

### Supplementary Note 8

The fuel cell system according to any one of the supplementary notes 1 to 7 may further include the coolant supply pump (126) that supplies the coolant to the fuel cell stack, wherein the control device may set a rotation speed of the coolant supply pump during execution of the water discharge in the first water discharge mode to be lower than a rotation speed of the coolant supply pump during execution of the water discharge in the second water discharge mode.

In this manner, it is possible to suppress an increase in the power consumption by the entire fuel cell system.

### Supplementary Note 9

The second disclosure is to provide the method of controlling the fuel cell system including: the fuel cell stack having the plurality of power generation cells configured to generate electrical power using the oxygen-containing gas and the fuel gas; the oxygen-containing gas supplier configured to supply the oxygen-containing gas to the fuel cell stack; the supply path through which the oxygen-containing gas to be supplied to the fuel cell stack flows; the discharge path through which the oxygen-containing gas discharged from the fuel cell stack flows; the temperature sensor configured to detect a temperature of the fuel cell stack; and the control device configured to control the oxygen-containing gas supplier, wherein the control device executes the stoppage operation in which power generation is continued until a predetermined condition is met after receipt of the system shutdown command; acquires the temperature of the fuel cell stack before the stoppage operation; determines whether the fuel cell stack is in moist condition on the basis of at least the temperature of the fuel cell stack acquired; enables execution of water discharge during execution of electrical power generation under the stoppage operation by selectively discharging water remaining in the fuel cell stack in either a first mode in which an amount of oxygen-containing gas supplied from the oxygen-containing gas supplier to the fuel cell stack is a first amount, or a second mode in which the amount is a second amount less than the first amount; executes the water discharge in the first mode during execution of electrical power generation under the stoppage operation, in a case that the fuel cell stack is determined to be in moist condition; and executes the water discharge in the second mode during execution of the electrical power generation under the stoppage operation, in a case that the fuel cell stack is determined not to be in moist condition.

With the arrangement described above, it is possible to facilitate removal of water from portions of the fuel cell stack through which water is difficult to flow. Further, with the arrangement described above, it is possible to discharge water from the fuel cell stack while suppressing excessive drying of the fuel cell stack. That is, with the arrangement described above, water can be appropriately discharged from the fuel cell stack.

The present invention is not limited to the above disclosure, and various modifications are possible without departing from the essence and gist of the present invention.

1. A fuel cell system comprising:
a fuel cell stack including a plurality of power generation cells configured to generate electrical power using an oxygen-containing gas and a fuel gas;
an oxygen-containing gas supplier configured to supply the oxygen-containing gas to the fuel cell stack;
a supply path through which the oxygen-containing gas to be supplied to the fuel cell stack flows;
a discharge path through which the oxygen-containing gas discharged from the fuel cell stack flows;
a temperature sensor configured to detect a temperature of the fuel cell stack; and
one or more processors that execute computer-executable instructions stored in a memory,
wherein the one or more processors execute the computer-executable instructions to cause the fuel cell system to:
execute electrical power generation under a stoppage operation in which power generation is continued until a predetermined condition is met after receipt of a system shutdown command;
acquire the temperature of the fuel cell stack before the stoppage operation;
determine whether the fuel cell stack is in moist condition on a basis of at least the temperature of the fuel cell stack acquired;
enable execution of water discharge during execution of electrical power generation under the stoppage operation by selectively discharging water remaining in the fuel cell stack in either a first mode in which an amount of oxygen-containing gas supplied from the oxygen-containing gas supplier to the fuel cell stack is a first amount, or a second mode in which the amount is a second amount less than the first amount;
execute the water discharge in the first mode during execution of electrical power generation under the stoppage operation, in a case that the fuel cell stack is determined to be in moist condition; and
execute the water discharge in the second mode during execution of the electrical power generation under the stoppage operation, in a case that the fuel cell stack is determined not to be in moist condition.

2. The fuel cell system according to claim 1, wherein the one or more processors cause the fuel cell system to:
determine whether the fuel cell stack is in moist condition on the basis of the temperature of the fuel cell stack and an output current value of the fuel cell stack.

3. The fuel cell system according to claim 2, wherein the one or more processors cause the fuel cell system to:
acquire the temperature of the fuel cell stack and the output current value of the fuel cell stack before starting the stoppage operation;
determine that the fuel cell stack is in a moist-condition-predicted state in a case that the temperature of the fuel cell stack is lower than a predetermined temperature threshold and the output current value is lower than a predetermined current threshold, and determine that the fuel cell stack is in moist condition in a case that the moist-condition-predicted state has continued for a predetermined time before starting the stoppage operation.

4. The fuel cell system according to claim 1, wherein each of the power generation cells comprises:
an assembly of an electrolyte membrane, an anode and a cathode, and
a pair of separators sandwiching the assembly, and
each of the separators comprises:
a reactant gas flow field through which the oxygen-containing gas or the fuel gas flows,
a seal surrounding the reactant gas flow field, and
a bypass stopping portion formed between an edge of the reactant gas flow field in a flow field width direction and the seal to prevent the oxygen-containing gas or the fuel gas from bypassing the reactant gas flow field.

5. The fuel cell system according to claim 1, wherein the one or more processors cause the fuel cell system to:
further determine whether the fuel cell stack is in moist condition during execution of the water discharge in the first mode, and
switch execution of the water discharge from the first mode to the second mode in a case that the fuel cell stack is determined to no longer be in moist condition during execution of the water discharge in the first mode.

6. The fuel cell system according to claim 5, wherein the one or more processors cause the fuel cell system to:
measure a first execution time which is an execution time of the water discharge in the first mode,
determine a second execution time which is an execution time of the water discharge in the second mode based on the first execution time, and
execute the water discharge in the second mode for the second execution time.

7. The fuel cell system according to claim 5, wherein the one or more processors cause the fuel cell system to:
measure a first execution time which is an execution time of the water discharge in the first mode,
determine a second execution time that is an execution time of the water discharge in the second mode by subtracting the first execution time from a preset water discharge time, and
execute the water discharge in the second mode for the second execution time.

8. The fuel cell system according to claim 1, further comprising:
a coolant supply pump that supplies a coolant to the fuel cell stack,
wherein the one or more processors cause the fuel cell system to:
set a rotation speed of the coolant supply pump during execution of the water discharge in the first mode to be lower than a rotation speed of the coolant supply pump during execution of the water discharge in the second mode.

9. A method of controlling a fuel cell system comprising:
a fuel cell stack including a plurality of power generation cells configured to generate electrical power using an oxygen-containing gas and a fuel gas;
an oxygen-containing gas supplier configured to supply the oxygen-containing gas to the fuel cell stack;
a supply path through which the oxygen-containing gas to be supplied to the fuel cell stack flows;
a discharge path through which the oxygen-containing gas discharged from the fuel cell stack flows; and
a temperature sensor configured to detect a temperature of the fuel cell stack,
the method comprising:
executing electrical power generation under a stoppage operation in which power generation is continued until a predetermined condition is met after receipt of a system shutdown command;
acquiring a temperature of the fuel cell stack before the stoppage operation;
determining whether the fuel cell stack is in moist condition on a basis of at least the temperature of the fuel cell stack acquired before the stoppage operation;
enabling execution of water discharge during execution of electrical power generation under the stoppage operation by selectively discharging water remaining in the fuel cell stack in either a first mode in which an amount of oxygen-containing gas supplied from the oxygen-containing gas supplier to the fuel cell stack is a first amount, or a second mode in which the amount is a second amount less than the first amount;
executing the water discharge in the first mode during execution of the electrical power generation under the stoppage operation, in a case that the fuel cell stack is determined to be in moist condition; and
executing the water discharge in the second mode during execution of the electrical power generation under the stoppage operation, in a case that the fuel cell stack is determined not to be in moist condition.
